(19) United States
(12) Patent Application Publication
(10) Pub. No.: US 2016/0239443 A1
(43) Pub. Date: Aug. 18, 2016

(54) DMA CONTROLLER

(71) Applicant: FANUC Corporation, Yamanashi (JP)

(72) Inventor: Masahiro MIURA, Yamanashi (JP)

(21) Appl. No.: 15/046,389

(22) Filed: Feb. 17, 2016

(30) Foreign Application Priority Data
Feb. 18, 2015 (JP) 2015-29813

(51) Int. Cl. G06F 13/30

(52) U.S. Cl. CPC G06F 13/30

(57) ABSTRACT

A direct memory access (DMA) controller issues a standby request a predetermined period of time before data transfer having a high priority starts and prohibits data transfer having a low priority in advance, and thus data transfer having a high priority can generate a transfer cycle from a data transfer start point in time without waiting. Accordingly, a transfer time is reduced, a variation in the transfer time is reduced, and thus a real time property of a system is improved.

### BACKGROUND OF THE INVENTION

1. Field of the Invention

The present invention relates to a direct memory access (DMA) controller, and more particularly, to a controller which is capable of starting transfer having a high priority without waiting for completion of transfer having a low priority.

2. Description of the Related Art

In computers, a direct memory access (DMA) scheme in which direct data transfer is performed between memories or devices without intervention of a CPU is used in order to perform efficient data transfer. As illustrated in FIG. 5, DMA transfer is controlled by a DMA controller 1, and data to be transferred includes network packet, image data, audio data, or the like.

The DMA controller performs burst mode transfer in which a plurality of pieces of data of consecutive addresses from a designated address are collectively transferred in a single cycle, and thus there is an advantage in which transfer can be performed at a higher speed than direct memory transfer by the CPU.

Further, since the DMA controller operates independently of the CPU, there is also an advantage in which the CPU can process another task while the DMA transfer is being performed.

Since there are cases in which the DMA controller is requested to perform various kinds of different data transfers at the same time, the DMA controller mostly has a function of managing a priority in order to efficiently process a plurality of data transfers. For example, JP 2003-271539 A discloses a technique of optimizing memory access by controlling data transfer according to a priority decided by a priority decision circuit in advance and thus improving the throughput of data transfer of the entire system.

Further, in the data transfer requested to the DMA controller, periodic activation may be requested, or a transfer time may be requested, and thus various items such as an activation condition or a condition of a transfer time in addition to a priority are set to the DMA controller. For example, JP 2003-006139 A discloses a technique of implementing data transfer of an expected transfer amount by comparing an expected value of a transfer amount with an actual transfer amount and deciding a priority in view of a comparison result.

Through this technique, it is possible to efficiently transfer a plurality of pieces of data having different priorities within a decided period of time.

In a system having a high real time property such as industrial equipment or an embedded system, a real time OS is employed, and a plurality of processes are scheduled and performed in order from a process having a high priority. Further, a specific process is arranged to be reliably completed within a decided period of time, for example, a process is performed after a system receives a certain input.

In a system in which a high real time property is required, there is a process having a high priority that has to be necessarily performed within a certain period of time (or that has to be processed as quickly as possible), and thus it is desirable that data transfer related to a process having a high priority be completed in the shortest possible period of time, and a variation in a transfer time be small.

As described above, in the DMA controllers of the related arts disclosed in JP 2003-271539 A and JP 2003-006139 A, a function of setting a priority to transfer data, controlling a priority so that transfer is performed within a set transfer time, and raising an alarm when transfer has not been performed within the transfer time is provided, but pursuit of a higher real time property for completing data transfer having a high priority in the shortest possible time or reducing the variation in the transfer time is not considered.

Since the DMA controller is used for the purpose of efficient transfer, the DMA controller commonly performs the burst mode transfer as described above. The burst mode is a mode in which a plurality of pieces of data of consecutive addresses from a designated address are collectively transferred in a single cycle. Thus, when the burst mode transfer is performed, a single cycle time tends to be increased. Particularly, the cycle time is further increased when access to a device having a slow response is performed, when conflict with another cycle occurs in a route to a transfer destination, or the like.

If data transfer having a high priority starts while data transfer having a low priority is being performed, it is difficult to start data transfer having a high priority until data transfer being performed is completed. As described above, when an execution cycle is large, a standby time is large as well. Thus, although scheduling is performed in view of a priority, there arises a problem in that data transfer having a high priority is on standby, or a transfer completion time varies.

An internal bus cycle of a system-on-chip (SoC) is several hundreds of nanoseconds, and a serial communication cycle is several microseconds, and thus it depends on a real time property required by a system whether or not influence thereof is ignorable.

Further, when data transfer having a high priority has started while data transfer having a low priority is being performed, it is not a problem if data transfer having a low priority can immediately be stopped. However, a DMA access destination is very diverse, such as a system internal memory, an external storage, or an external device connected via a communication line, and is not necessarily able to stop a transfer cycle immediately.

### SUMMARY OF THE INVENTION

In this regard, it is an object of the present invention to provide a DMA controller which is applicable to a system having a high real time property such as industrial equipment or an embedded system and capable of completing data transfer associated with a process having a high priority in the shortest possible time and reducing the variation in the transfer time.

A DMA controller controlling DMA transfer according to the present invention includes a plurality of transfer request generating units, each of the transfer request generating units notifying a scheduler of a transfer request based on transfer request setting information including at least a transfer setting number and a transfer activation condition set thereto, the scheduler receiving the transfer requests from the plurality of transfer request generating units, scheduling the received transfer requests based on priority setting information set in advance, selecting one transfer setting number corresponding to a transfer setting commanded by the transfer request serving as an execution target based on a scheduling result, and notifying a DMA transfer executing unit of the selected transfer setting number, and the DMA transfer executing unit receiving the notified transfer setting number from the scheduler, reading transfer setting information corresponding to the received transfer setting number from a plurality of pieces of transfer setting information set in advance, and executing the DMA transfer. The transfer request setting information includes a preceding standby time, the transfer request generating unit notifies the scheduler of a standby request before the transfer request based on the preceding standby time, and the scheduler receives the standby request, and gives a standby notification to the DMA transfer executing unit based on the priority setting information that has been set in advance.

The transfer request generating unit can receive the transfer request and the standby request from an outside of the DMA controller and notify the scheduler of the received transfer request and the standby request.

According to the present invention, data transfer having a high priority can generate a transfer cycle from a data transfer start point in time without waiting, and thus an effect in which the transfer time is reduced, and the variation in the transfer time is reduced is obtained. Accordingly, the real time property of the system is improved.

### BRIEF DESCRIPTION OF THE DRAWINGS

The above and other objects and features of the present invention will become more apparent from description of the following embodiments thereof with reference to the attached drawings in which:

FIG. 1 is a schematic block diagram of a DMA controller according to an embodiment of the present invention;

FIG. 2 is a diagram for describing DMA transfer control using a preceding standby time by a DMA controller according to the present invention;

FIG. 3 is a diagram illustrating an example of controlling two DMA transfer requests having different priorities by a DMA controller according to the present invention;

FIG. 4 is a diagram for describing DMA transfer control based on an external input signal by a DMA controller according to the present invention; and

FIG. 5 is a diagram for describing DMA transfer.

### DETAILED DESCRIPTION OF THE PREFERRED EMBODIMENTS

A DMA controller according to the present invention issues a standby request a predetermined period of time before data transfer having a high priority starts and prohibits data transfer having a low priority in advance. As a result, solved is the problem of the related art in which data transfer having a high priority is forced to wait when it is desired to start data transfer having a high priority while data transfer having a low priority is being executed.

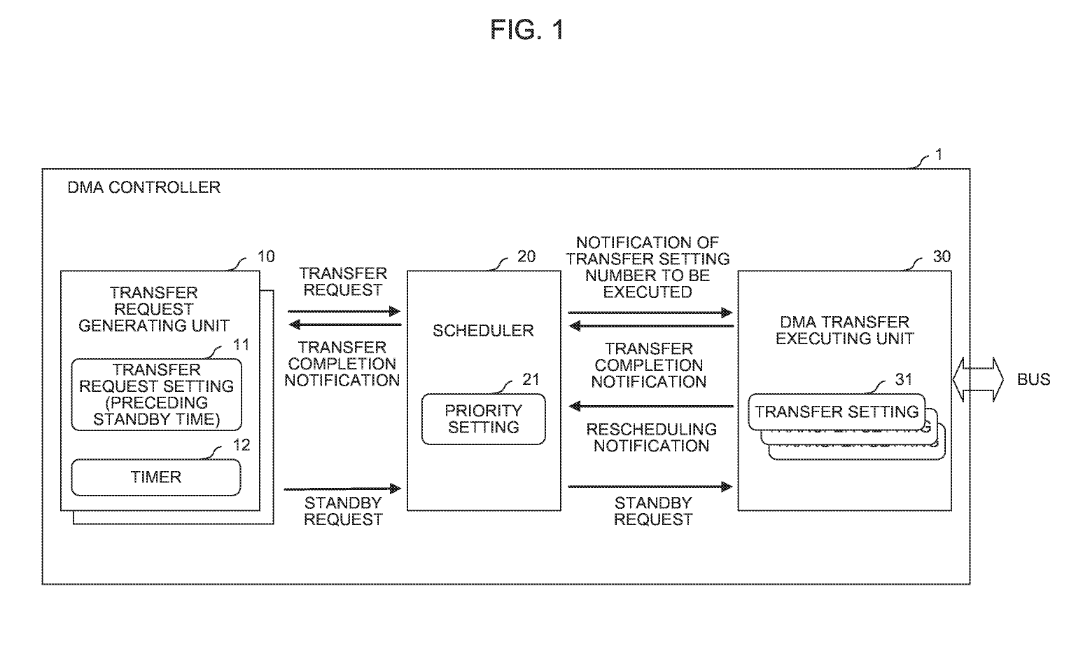

A DMA controller according to an embodiment of the present invention will be described with reference to FIG. 1.

A DMA controller 1 includes a transfer request generating unit 10, a scheduler 20, and a DMA transfer executing unit 30.

A plurality of transfer request generating units 10 are arranged in one DMA controller 1, and each of the transfer request generating units 10 undertakes a role of notifying the scheduler 20 of a transfer request for requesting data transfer, and different transfer request settings 11 can be performed on the respective transfer request generating units 10. When an activation condition set to the transfer request setting 11 is satisfied, the transfer request generating unit 10 notifies the scheduler 20 of a transfer request including a transfer setting number. For example, periodic activation using a timer 12 or random activation using an external activation signal can be set to the transfer request setting 11 of the transfer request generating unit 10. The transfer request generating unit 10 receives a transfer completion notification from the scheduler and clears the transfer request.

The scheduler 20 receives the transfer requests from the plurality of transfer request generating units 10, and selects one transfer request from among the plurality of received transfer request according to a priority setting that has been performed in advance. Then, the scheduler 20 notifies the DMA transfer executing unit 30 of the transfer setting number corresponding to the selected transfer request (scheduling). Further, the scheduler 20 notifies the corresponding transfer request generating unit 10 of the transfer completion notification received from the DMA transfer executing unit 30. The scheduler 20 has a function of performing rescheduling when a rescheduling notification is received from the DMA transfer executing unit 30 or when a specific transfer request is received.

The DMA transfer executing unit 30 receives the transfer setting number notification from the scheduler 20, reads various kinds of transfer information such as a transfer source address, a transfer destination address, a transfer data amount, the number of transfer cycles, and a rescheduling notification setting from a transfer setting 31 of a corresponding number, and generates a DMA transfer cycle. The transfer setting 31 is set in advance, for example, when an initial setting is performed at the time of system activation and managed with the transfer setting number associated.

The DMA transfer executing unit 30 issues the rescheduling notification to the scheduler 20 according to the rescheduling notification setting of the transfer setting each time one or more of writing cycles end. Meanwhile, the scheduler 20 receives the rescheduling notification and performs scheduling again. When the transfer is completed, the DMA transfer executing unit 30 gives the transfer completion notification to the scheduler 20, the scheduler 20 that has received the transfer completion notification gives the transfer completion notification to the corresponding transfer request generating unit 10, and the transfer request generating unit 10 that has received the transfer completion notification clears the transfer request.

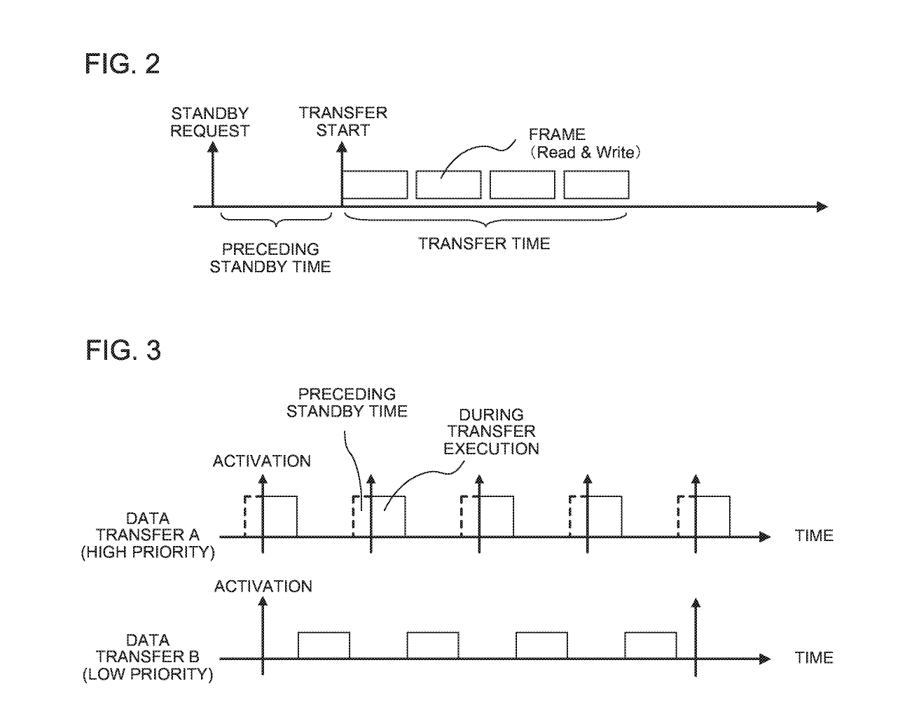

The DMA controller according to the present invention can set a preceding standby time to the transfer request setting 11 of the transfer request generating unit 10 and notify the scheduler 20 of a standby request before a predetermined period of time from a time at which the notification of the transfer request is given as illustrated in FIG. 2. Thus, it is possible to cause the DMA controller to be on standby before a predetermined period of time from a time at which the transfer starts, and it is possible to start the transfer without being disturbed by a transfer cycle having a low priority. As a result, it is possible to perform the DMA transfer according to a setting timing, and it is possible to reduce a DMA transfer time and reduce a variation in a DMA transfer completion time.

FIG. 3 illustrates examples of transfer timings of data transfer A having a high priority and data transfer B having a low priority.

In these examples, as illustrated in FIG. 3, the data transfer A is activated periodically by a timer, and the preceding standby time is set to be valid. The data transfer B is assumed to be activated with a larger cycle than the data transfer A. When this transfer setting has been performed, scheduling is performed by the scheduler 20 such that the data transfer B is executed in a time zone until the subsequent preceding standby time starts after the data transfer A is completed.

As described above, when the transfer request is periodically generated using the timer, the timing at which the notification of the standby request is given can be calculated in the DMA controller 1 according to the set preceding standby time. On the other hand, when the transfer request is randomly generated according to the external input signal, it is necessary to notify the DMA controller of the time at which the notification of the standby request is given.

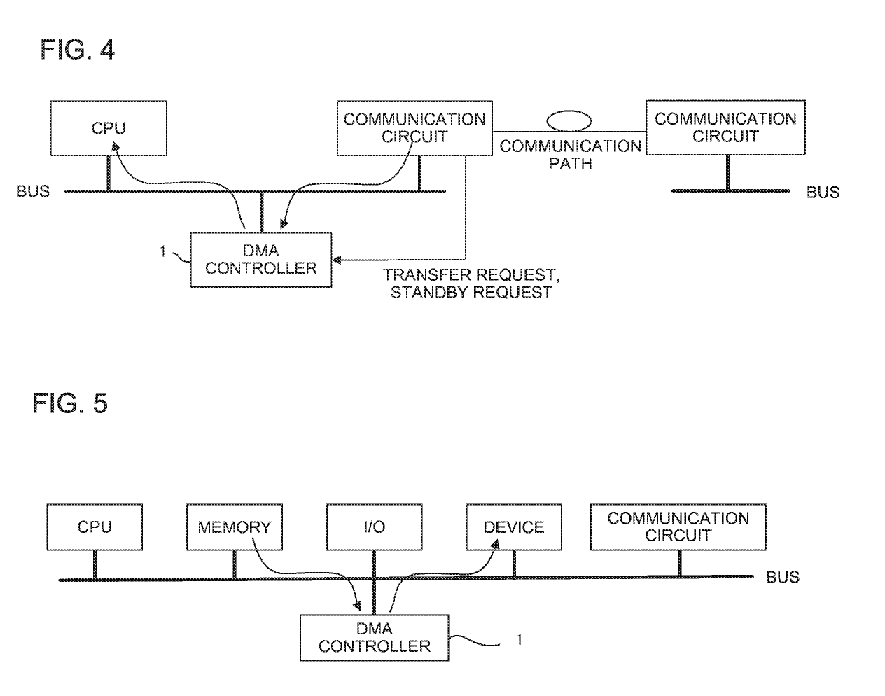

For example, as illustrated in FIG. 4, when a communication circuit is assumed to receive a packet, write received data in a reception memory, and then activate the DMA controller using an external input signal, the communication circuit can notify the DMA controller of the standby request at a timing such as a stage in which the packet is received or before received data is written in the reception memory. Thus, even when the DMA transfer is randomly activated from an external device, it is possible to start transfer having a high priority without waiting for completion of transfer having a low priority.

1. A direct memory access (DMA) controller controlling DMA transfer, comprising:
a plurality of transfer request generating units, each of the transfer request generating units notifying a scheduler of a transfer request based on transfer request setting information including at least a transfer setting number and a transfer activation condition set thereto;
the scheduler receiving the transfer requests from the plurality of transfer request generating units, scheduling the received transfer requests based on priority setting information set in advance, selecting one transfer setting number corresponding to a transfer setting commanded by the transfer request serving as an execution target based on a scheduling result, and notifying a DMA transfer executing unit of the selected transfer setting number; and
the DMA transfer executing unit receiving the notified transfer setting number from the scheduler, reading transfer setting information corresponding to the received transfer setting number from a plurality of pieces of transfer setting information set in advance, and executing the DMA transfer,
wherein the transfer request setting information includes a preceding standby time,
the transfer request generating unit notifies the scheduler of a standby request before the transfer request based on the preceding standby time, and
the scheduler receives the standby request, and gives a standby notification to the DMA transfer executing unit based on the priority setting information set in advance.

2. The DMA controller according to claim 1,
wherein the transfer request generating unit receives the transfer request and the standby request from an outside of the DMA controller, and notifies the scheduler of the received transfer request and the standby request.
